(19) United States
(12) Patent Application Publication
(10) Pub. No.: US 2003/0183599 A1
(43) Pub. Date: Oct. 2, 2003

(54) High selective ratio and high and uniform plasma processing method and system

(76) Inventors: Masashi Kikuchi, Chigasaki-shi (JP); Hitoshi Ikeda, Chigasaki-shi (JP); Kiyoshi Kuwahara, Susono-shi (JP); Toshio Hayashi, Susono-shi (JP); Noriyuki Harashima, Chichibu-shi (JP); Takaei Sasaki, Chichibu-shi (JP)

Correspondence Address: LARSON & TAYLOR, PLC, 1199 NORTH FAIRFAX STREET, SUITE 900, ALEXANDRIA, VA, 22314, US

(21) Appl. No.: 10/393,283

(22) Filed: Mar. 21, 2003

(30) Foreign Application Priority Data
Mar. 26, 2002 (JP) 2002-86352

(51) Int. Cl. C03C 25/68

(52) U.S. Cl. 216/68; 216/69

(57) ABSTRACT

A plasma processing method and a plasma processing system provide advantages of a high degree of selectivity, a large area processing capability and an enhanced precision level. A plasma processing method according to the invention is so designed that a pulse modulation power is supplied alternately to the plasma generating power supply and the substrate bias power supply by referring to the time taken by gas to diffuse from the center of electric discharge to the substrate. In a plasma processing system according to the invention, the plasma generating power supply and the substrate bias power supply are provided with modulation means for supplying a pulse modulation power alternately to the plasma generating section and the substrate electrode by referring to the time taken by gas to diffuse from the center of electric discharge to the substrate.

### BACKGROUND OF THE INVENTION

1. Field of the Invention

The present invention relates to a plasma processing method and a plasma processing system that can be used for etching or CVD in a process of manufacturing an exposure mask, a micro-electronic device, a medical micro-chip or a micro-machine, utilizing electric discharge plasma.

2. Related Background Art

Known plasma etching techniques include the use of a CW (continuous wave) plasma reactor that comprises a temporally continuous plasma generating means.

Various etching methods and etching systems that utilize pulse modulated plasma have been proposed. For instance, Japanese Patent No. 3042450 discloses an etching method of turning processing gas into plasma by utilizing a radio frequency electric field in a plasma generating chamber and irradiating generated plasma to a substrate, with which the radio frequency electric field is modulated within a specific range and the pulse rising time is specified to suppress any overshooting of electron temperature in plasma and increase the amount of negative ions in plasma in order to reduce the accumulation of electric charge.

Japanese Patent No. 3085151 discloses an etching method and an etching system adapted to accelerate electrons by applying a pulse bias voltage to a specimen in order to prevent the positive charge at the bottom surface of a micro-pattern from going up and detect the DC component of the voltage being applied to the specimen in order to control the pulse cycle, the pulse width and the pulse amplitude and eliminate the difference between the detected value and the specified value so that the electron accelerating voltage and the ion accelerating voltage may be held to predetermined respective levels.

Japanese Patent No. 3201223 discloses an etching method and an etching system of turning gas into plasma under reduced pressure and applying a pulse bias voltage showing a positive potential to the specimen electrode so as to make the ratio of the pulse width to the pulse cycle (duty ratio) to be found within a predetermined range and also the DC component of the voltage being applied to the specimen to be found within a predetermined range in order to accelerate electrons in plasma before striking on the specimen so as to neutralize at least part of the surface electric charge of the specimen when processing the specimen in the processing chamber using plasma.

When a metal film or an Si film is subjected to high precision etching in a system of the above identified type, there can arise a problem of a degraded etching performance that is mostly attributable to the opening ratio of the surface to be etched and/or the CD (critical dimension) loss of the mask. Methods of selectively etching the object to be etched by adding a solid material or a gas seed to the surface of the mask in order to harden the mask or forming a protection film on the mask surface have been proposed. However, such methods are accompanied by drawbacks including complexity of process and a limited area that can be processed by etching.

The distance between plasma and the substrate to be utilized for diffusion of etchant is routinely adjusted for the purpose of improving the intra-planar distribution of etching rate on the substrate so as to be able to process a large area. However, this technique by turn gives rise to additional problems including a reduced selectivity and a lowered etching rate.

### BRIEF SUMMARY OF THE INVENTION

In view of the above identified circumstances, it is therefore the object of the present invention to provide a plasma processing method and a plasma processing system that provide advantages of a high degree of selectivity, a large area processing capability and an enhanced precision level.

In an aspect of the present invention, the above object is achieved by providing a method of uniformly plasma-processing a substrate on a substrate electrode at a high selectivity ratio and over a large area by generating plasma in the plasma generating section of a vacuum container by means of a radio frequency antenna circuit and a plasma generating power supply connected to the radio frequency antenna circuit and supplying modulated substrate bias power to the substrate electrode in the vacuum container from a substrate bias power supply, wherein a pulse modulation power is supplied alternately to the plasma generating power supply and the substrate bias power supply by referring to the time taken by gas to diffuse from the center of electric discharge to the substrate.

With the above defined method according to the present invention, which can be applied to plasma etching, a spatially even or uneven and temporally constant or modulated magnetic field is applied to the plasma generating section of the vacuum container and the rates of applications of various etchants to the substrate surface to be processed and the spatial distributions of the etchants on the substrate surface are controlled independently in terms of the object of etching and the mask as a function of the combination of process parameters including the types of gases to be used for plasma-processing, the mixing ratio of the gases, the gas pressure, the gas flow rate, the distance between plasma and the substrate in terms of the plasma generating section and the substrate surface, the magnetic field distribution, the modulation of plasma generating power as determined on the basis of a repetition frequency between 50 Hz and 1 MHz, a duty ratio between 10 and 90% and an average power supply rate of not more than 3 kW and the modulation of substrate bias power as determined on the basis of a repetition frequency between 50 Hz and 1 MHz, a duty ratio between 10 and 90% and an average power supply rate of not more than 100W.

With the method according to the invention, non-magnetic induction plasma, non-magnetic microwave plasma or magneto-microwave plasma is used.

When the method according to the invention is applied to plasma etching, the pulse modulation is conducted according to both the power supplied to the radio frequency antenna circuit and the substrate bias power supplied to the substrate electrode by referring to the diffusion time or the service life of echant.

Priority may be given to the fall of echant striking on the substrate for the object of etching to suppress the fall of etchant striking on the substrate for the mask by supplying substrate bias power in synchronism with the generation of pulse plasma.

With the method according to the invention, a composite pulse of plasma generating power and substrate bias power may be formed by means of a temporal-change-free rectangular modulation wave for the specified value of the repetition frequency and that of the duty ratio. Alternatively, either or both of plasma generating power modulation or substrate bias power modulation, a combination and/or overlapping of CWs (continuous waves) or various waveforms may be used.

With the method according to the invention, the conditions of plasma generating power modulation and those of substrate bias power modulation may be maintained, modified or temporally changed depending on conditions including the types of gases, the mixing ratio of gases, the gas pressure and/or addition or replacement of gas seeds by means of a gas puff.

In another aspect of the present invention, there is provided a system for uniformly plasma-processing a substrate on a substrate electrode at a high selectivity ratio-and over a large area by applying a spatially even or uneven and temporally constant or modulated magnetic field to the plasma generating section of a vacuum container, generating plasma by means of a radio frequency antenna circuit and a plasma generating power supply connected to the radio frequency antenna circuit and supplying modulated substrate bias power to the substrate electrode in the vacuum container from a substrate bias power supply, the plasma generating power supply and the substrate bias power supply being provided with modulation means for supplying a pulse modulation power alternately to the plasma generating section and the substrate electrode by referring to the time taken by gas to diffuse from the center of electric discharge to the substrate.

The plasma-processing of a system according to the present invention is plasma etching, and the modulation means provided at the plasma generating power supply and the substrate bias power supply is so arranged as to conduct the pulse modulation according to both the power supplied to the radio frequency antenna circuit and the substrate bias power supplied to the substrate electrode by referring to the diffusion time or the service life of echant.

The radio frequency antenna circuit of a system according to the present invention for generating induction discharge plasma in the plasma generating section of the vacuum container may be provided with a single winding coil or a parallel coil having a plurality of windings and adapted to be able to regulate the inter-gap distance independently in the azimuth direction.

### BRIEF DESCRIPTION OF THE DRAWING

FIG. 1 is an embodiment of the present invention applied to a plasma etching system.

### DESCRIPTION OF THE PREFERRED EMBODIMENT

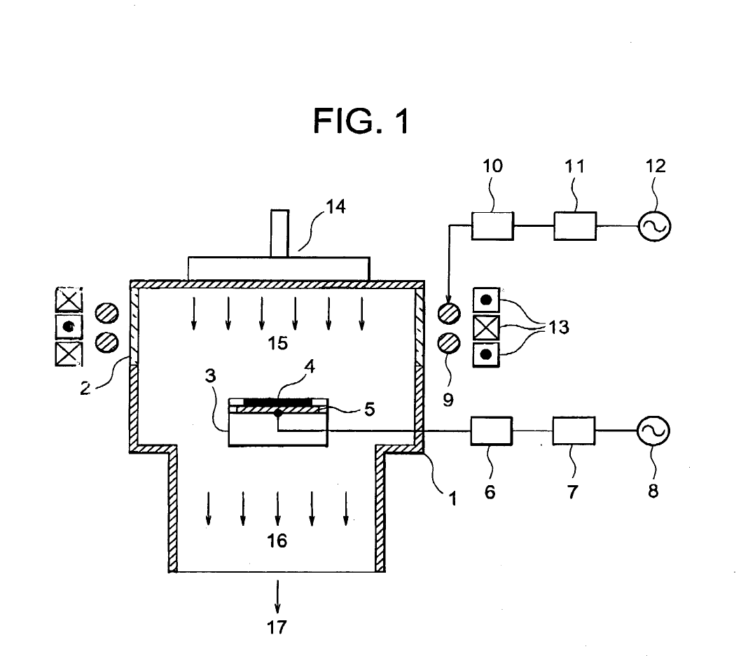

Now, the present invention will be described in greater detail by referring to the accompanying drawing that illustrates a preferred embodiment of the invention. The illustrated embodiment is a plasma etching system utilizing magnetic neutral line discharge plasma. Referring to FIG. 1, reference symbol 1 denotes a vacuum container or chamber that is provided with a power introducing dielectric wall 2 to be used for generating radio frequency plasma. Reference symbol 3 denotes a substrate support table on which a substrate 4 is mounted and which is provided with a substrate electrode 5. The substrate electrode 5 is connected to a bias applying power supply 8 for applying bias to the substrate by way of an impedance matching circuit 6 and a modulation circuit 7.

The vacuum container 1 is provided outside of the dielectric wall 2 with a radio frequency power supply antenna 9, which radio frequency power supply antenna 9 is connected to a radio frequency power supply 12 by way of an impedance matching circuit 10 and a modulation circuit 11. The modulation circuit 11 modulates the radio frequency power according to various process parameters. Three solenoid coils 13 are arranged outside the radio frequency power supply antenna 9. The solenoid coils 13 are arranged in such a way that they provide positional coordination of magnetic fields adapted to generate magnetic neutral line discharge plasma in the plasma generating region 15 in the inside of the dielectric wall 2 of the vacuum container 1. Thus, an annular magnetic neutral line is formed in the space inside the dielectric wall 2 of the vacuum container 1.

An etching gas introduction mechanism 14 is fitted to the top plate of the vacuum container 1 so that etching gas may be introduced into the plasma generating region 15 in the inside of the dielectric wall 2 of the vacuum container 1 by way of the top plate of the vacuum container. The etching gas introduced from the etching gas introducing mechanism 14 is made to pass through the plasma generating region 15, where it is decomposed, and flow to an appropriate exhaust system 17 from the surface region of the etching substrate 4 by way of an exhaust port 16.

In the etching system having the above described configuration, etching gas that is made to flow at a controlled rate is introduced from the etching gas introducing mechanism 14 into the plasma generating region 15 in the inside of the vacuum container 1 by way of the top plate of the vacuum container 1 whose internal pressure is controlled. Radio frequency power that is modulated by the modulation circuit 11 according to various process parameters is supplied from the radio frequency power supply antenna 9 by way of the dielectric wall 2 to the plasma generating region 15 in the inside of the vacuum container 1. As a result, modulated discharge plasma is generated in the plasma generating region 15.

Meanwhile, since various mechanisms are provided in the vacuum container 1 for generating, diffusing and extinguishing plasma as a function of different decomposition seeds, it is necessary to independently control the rates at which the etchant for the object of etching and the etchant for the mask are made to fall respectively on the substrate 4 in order to efficiently conduct the operation of selective etching and it is important to control the spatial distribution of generated plasma in order to improve the intra-planar distribution of etching characteristic. Thus, the modulation of the application of a magnetic field (e.g., the magnetic filed for forming a magnetic neutral line in the case of the illustrated embodiment) and that of the electric power supply to the inside of the vacuum container 1 are controlled according to the invention.

This will be described by way of a specific example.

In the example, the flow rate of chlorine gas and that of oxygen gas were respectively made equal to 240 sccm and 60 sccm and gas pressure was made equal to 0.67 Pa, while no magnetic field was applied or the magnetic field gradient of the magnetic neutral line was made equal to 1 Gauss/cm. The supply rate of radio frequency power to the antenna 9 was between 1 and 3 kW and the repetition frequency of the rectangular wave and the duty ratio were respectively between 56 and 167 Hz and between 33 and 100%, whereas the supply rate of bias power to the substrate electrode 5 was 20W and the repetition frequency of the rectangular wave and the duty ratio were respectively between 50 and 250 Hz and between 0 and 100%. The distance between plasma and the substrate 4 was made equal to 220 mm.

Under the above conditions, the etching characteristic of the resist and that of the Cr film on the surface of a 6.3 mm thick 6-inch square quartz substrate were checked. As a result, it was found that highly selective etching and large area uniform etching can be combined in a process using an etchant-diffusion-time-synchronized type composite pulse by conducting a pulse modulation on both the power supplied to the antenna 9 and the substrate bias power supplied to the substrate electrode 5 by referring to the diffusion time or the service life of etchant. As a result, it was found that a large area ultra-precision etching operation can be realized.

Now, the large area ultra-precision etching method using an etchant-diffusion-time-synchronized type composite pulse will be described in detail.

Firstly various physical variables are defined as follows.

Tₜ, τₜ: production time of etchant from pulse application and diffusion time of etchant to get to the substrate surface in terms of the object of etching.

Tₘ, τₘ: production time of etchant from pulse application and diffusion time of etchant to get to the substrate surface in terms of the mask.

Tₒₙ, τ_{off}: on time and off time of pulse.

Various etchants are produced in the vacuum container 1 by pulse plasma for the object of etching and the mask in the vacuum container 1. Each of the ethants is diffused and mostly extinguished but partly gets to the surface of the etching substrate 4 in the gas flowing environment. The first point important for selective etching is that it is necessary to consider the conditions of the high repetition frequency for Tₒₙ>Tₜ, T_{off}<τₜ. If the service life is shorter than the diffusion time, the diffusion time may well be replaced by the service life under the above conditions. On the other hand, it is practically desirable to use a low frequency region for the repetition frequency and select a low duty ratio, considering ease of impedance matching and suppression of production of etchants (suppression of production of etchant is effective for the mask when Tₒₙ<Tₜ, T_{off}>τₜ). In the above example, it was confirmed that, as the repetition frequency was raised and the duty ratio was reduced, the selectivity ratio was increased to realize a maximum improvement of 200% under the conditions of Tₒₙ>>Tₜ, T_{off}=4 to 12 ms and τₜ=20 ms if compared with a process using unmodulated CWs.

The second point important for selective etching is that priority is given to the falls of etchants striking on the substrate for the object of etching to suppress the fall of etchant striking on the substrate for the mask to improve the selectivity by supplying substrate bias power in synchronism with the generation of pulse plasma. For this purpose, the electric power, the repetition frequency and the duty ratio are determined by considering the delay time due to the diffusion of etchant conducted in synchronism with the timing of Tₒₙ. In the above example, pulse power was supplied to the substrate for 10 to 50% Tₒₙ time to find that the selectivity ratio was improved maximally by 20% as a result of reduction in the duty ratio.

While the present invention is described above in terms of high selectivity etching, it is possible to improve the intra-planar distribution of etching rate by means of plasma modulation and substrate bias power modulation without adjusting the distance between plasma and the substrate. In the case of the above example, the intra-planar uniformity was improved by 1% along the edges of the resist film if compared with the use of magnetic neutral line discharge plasma at the time of supplying RF power with unmodulated CWs. Thus, it is possible to realize large area ultra-precision etching as a result of eliminating the drawbacks of conventional processes by means of the above described series of composite pulse processes.

Additionally, according to the invention, it is possible to form a composite pulse of plasma generating power and substrate bias power by means of a temporal-change-free rectangular modulation wave for the specified value of the repetition frequency and that of the duty ratio.

Still additionally, it is possible to realize large area precision etching by using either or both of plasma generating power modulation or substrate bias power modulation, a combination and/or overlapping of CWs (continuous waves) or various waveforms when the conditions of plasma generating power modulation and those of substrate bias power modulation may be maintained, modified or temporally changed depending on conditions including the types of gases, the mixing ration of gases, the gas pressure and/or addition or replacement of gas seeds by means of a gas puff.

Furthermore, in addition to composite pulse modulation as described above, it is also possible to use not only temporal swings of magnetic neutral line produced by solenoid coils or permanent magnets or a combination thereof but also temporal modulation of positional coordination of magnetic fields in the magneto-microwave plasma reactor to improve the intra-planar distribution of etching characteristic.

While an etching process in a magnetic neutral line discharge plasma system using a radio frequency power supply is described by referring to the illustrated embodiment, similar effects may be achieved when such a system is applied to a CVD process. Furthermore, similar effects may be achieved when such a system is applied to an etching and CVD process in a microwave plasma or ICP reactor.

Advantages of the Invention

As described above in detail, with a method of plasma-processing a substrate on a substrate electrode by generating plasma in the plasma generating section of a vacuum container by means of a radio frequency antenna circuit and a plasma generating power supply connected to the radio frequency antenna circuit and supplying modulated substrate bias power to the substrate electrode in the vacuum container from a substrate bias power supply according to the invention, it is possible to perform a plasma processing operation uniformly over a large area at a high selectivity ratio without making the process complex because a pulse modulation power is supplied alternately to the plasma generating power supply and the substrate bias power supply by referring to the time taken by gas to diffuse from the center of electric discharge to the substrate.

When a plasma processing method according to the invention is applied to an etching operation, the intra-planar uniformity is improved by 1% along the edges of the resist film of a 6-inch square substrate if compared with an etching operation using magnetic neutral line discharge plasma with unmodulated CWs. Additionally, selectivity is improved by not less than 200% if compared with an etching operation using induction discharge plasma with CWs. Thus, large area ultra-precision etching can be realized by the present invention.

A plasma processing system according to the invention can uniformly plasma-process a large area at a high selectivity ratio because the plasma generating power supply and the substrate bias power supply are provided with modulation means for supplying a pulse modulation power alternately to the plasma generating section and the substrate electrode by referring to the time taken by gas to diffuse from the center of electric discharge to the substrate.

1. A method of uniformly plasma-processing a substrate on a substrate electrode at a high selectivity ratio and over a large area by generating plasma in the plasma generating section of a vacuum container by means of a radio frequency antenna circuit and a plasma generating power supply connected to the radio frequency antenna circuit and supplying modulated substrate bias power to the substrate electrode in the vacuum container from a substrate bias power supply, wherein
a pulse modulation power is supplied alternately to the plasma generating power supply and the substrate bias power supply by referring to the time taken by gas to diffuse from the center of electric discharge to the-substrate.

2. A method according to claim 1, wherein
a spatially even or uneven and temporally constant or modulated magnetic field is applied to the plasma generating section of the vacuum container, and the rates of applications of various etchants to the substrate surface to be processed and the spatial distributions of the etchants on the substrate surface are controlled independently in terms of the object of etching and the mask as a function of the combination of process parameters including the types of gases to be used for plasma-processing, the mixing ratio of the gases, the gas pressure, the gas flow rated, the distance between plasma and the substrate in terms of the plasma generating section and the substrate surface, the magnetic field distribution, the modulation of plasma generating power as determined on the basis of a repetition frequency between 50 Hz and 1 MHz, a duty ratio between 10 and 90% and an average power supply rate of not more than 3 kW and the modulation of substrate bias power as determined on the basis of a repetition frequency between 50 Hz and 1 MHz, a duty ratio between 10 and 90% and an average power supply rate of not more than 100W.

3. A method according to claim 1, wherein
non-magnetic induction plasma, or non-magnetic microwave plasma or magneto-microwave plasma is used.

4. A method according to claim 1, wherein
the plasma processing is plasma etching and the pulse modulation is conducted according to both the power supplied to the radio frequency antenna circuit and the substrate bias power supplied to the substrate electrode by referring to the diffusion time or the service life of echant.

5. A method according to claim 1, wherein
priority is given to the fall of echant striking on the substrate for the object of etching to suppress the fall of etchant striking on the substrate for the mask by supplying substrate bias power in synchronism with the generation of pulse plasma.

6. A method according to claim 1, wherein
a composite pulse of plasma generating power and substrate bias power is formed by means of a temporal-change-free rectangular modulation wave for the specified value of the repetition frequency and that of the duty ratio.

7. A method according to claim 11, wherein
either or both of plasma generating power modulation or substrate bias power modulation, a combination and/or overlapping of continuous waves or various waveforms are used.

8. A method according to claim 1, wherein
conditions of plasma generating power modulation and those of substrate bias power modulation are maintained, modified or temporally changed depending on conditions including the types of gases, the mixing ratio of gases, the gas pressure and/or addition or replacement of gas seeds by means of a gas puff.

9. A system for uniformly plasma-processing a substrate on a substrate electrode at a high selectivity ratio and over a large area by applying a spatially even or uneven and temporally constant or modulated magnetic field to the plasma generating section of a vacuum container, generating plasma by means of a radio frequency antenna circuit and a plasma generating power supply connected to the radio frequency antenna circuit and supplying modulated substrate bias power to the substrate electrode in the vacuum container from a substrate bias power supply, wherein
the plasma generating power supply and the substrate bias power supply are provided with modulation means for supplying a pulse modulation power alternately to the plasma generating section and the substrate electrode by referring to the time taken by gas to diffuse from the center of electric discharge to the substrate.

10. A system according to claim 9, wherein
the plasma processing is plasma etching and the modulation means provided at the plasma generating power supply and the substrate bias power supply are so arranged as to conduct the pulse modulation according to both the power supplied to the radio frequency antenna circuit and the substrate bias power supplied to the substrate electrode by referring to the diffusion time or the service life of echant.

11. A system according to claim 9, wherein
the radio frequency antenna circuit for generating induction discharge plasma in the plasma generating section of the vacuum container comprises a single winding coil.

12. A system according to claim 9, wherein
the radio frequency antenna circuit for generating induction discharge plasma in the plasma generating section of the vacuum container comprises a parallel coil having a plurality of windings and adapted to be able to regulate the inter-gap distance independently in the azimuth direction.
